(19) United States
(12) Patent Application Publication
(10) Pub. No.: US 2011/0150128 A1
(43) Pub. Date: Jun. 23, 2011

(54) MODULATION DEVICE AND METHOD

(76) Inventor: Masazumi Yamazaki, Kanagawa (JP)

(21) Appl. No.: 13/061,229

(22) PCT Filed: Nov. 10, 2009
(86) PCT No.: PCT/JP2009/005988

§ 371 Date: Feb. 28, 2011

(30) Foreign Application Priority Data
Nov. 13, 2008 (JP) 2008-291193

(51) Int. Cl. H04L 27/00

(52) U.S. Cl. 375/295

(57) ABSTRACT

A modulation device, which reduces out-of-band leakage of a modulated signal while avoiding reduction in resistance to multipath interference, includes: a modulator configured to generate a modulated signal having a predetermined frequency band in a symbol-by-symbol manner according to an input signal; a signal processor configured to remove components in the predetermined frequency band from a portion of the modulated signal including a symbol period boundary, to generate a desired-component removed modulated signal; and a subtracter configured to subtract the desired-component removed modulated signal from the modulated signal generated by the modulator and output the result.

### TECHNICAL FIELD

The present disclosure relates to a modulation device that generates a modulated signal.

### BACKGROUND ART

As modulation schemes for achieving high-speed data transmission in the mobile communication environment, an orthogonal frequency division multiplex (OFDM) scheme and a discrete Fourier transform (DFT)-spread OFDM scheme are known for their enhanced frequency use efficiency and resistance to multipath interference.

Signals in the OFDM scheme and the DFT-spread OFDM scheme may cause out-of-band leakage because the amplitude and phase of the signals are discontinuous between adjacent symbol periods. Out-of-band leakage of an output signal of a modulator, as well as spectrum regrowth that is a distortion caused by nonlinearity of a power amplifier at a stage subsequent to the modulator, are superimposed, disturbing adjacent radio channels. This disturbance reduces the data transmission capacity of the entire mobile communication system. Therefore, in a general mobile communication system, standards have been established on adjacent channel leakage power, spectrum emission mask, etc. Mobile terminals and base stations are required to suppress out-of-band leakage and spectrum regrowth so as to conform to the standards.

To suppress spectrum regrowth caused by a power amplifier, it is necessary to operate the power amplifier linearly. However, this will reduce the efficiency, causing problems such as increase in power consumption and increase in heat generation. In consideration of this, it is first required to reduce the out-of-band leakage of the output signal of the modulator to a sufficiently small value.

Patent Document 1 describes a transmitter that performs waveform shaping for a plurality of signals individually and combines the waveform-shaped signals together. Non-Patent Document 1 describes waveform-shaping of a signal performed by multiplying each of symbol periods constituting the signal by a window function.

### CITATION LIST

### Patent Document

Patent Document 1: Japanese Patent Publication No. 2008-78790

### Non-Patent Document

Non-Patent Document 1: Lucent Technologies, France Telecom, “Windowing and Spectral Containment for OFDM Downlink,” 3GPP TSG-RAN WG1 Meeting #42bis, R1-051203, October, 2005

### SUMMARY OF THE INVENTION

### Technical Problem

In the waveform shaping described above, the modulated signal is shaped so that the level gradually decreases in a segment near a symbol period boundary. In this case, as the length of this segment (ramp length) is larger, the reduction amount of out-of-band leakage increases, but interference of a symbol with a cyclic prefix (CP) added to the subsequent symbol increases. Thus, the reduction in out-of-band leakage causes a problem of reducing the resistance to multipath interference.

It is an objective of the present invention to reduce out-of-band leakage of a modulated signal while avoiding reduction in resistance to multipath interference.

### Solution to the Problem

The modulation device of an example embodiment of the present invention includes: a modulator configured to generate a modulated signal having a predetermined frequency band in a symbol-by-symbol manner according to an input signal; a signal processor configured to remove components in the predetermined frequency band from a portion of the modulated signal including a symbol period boundary, to generate a desired-component removed modulated signal; and a subtracter configured to subtract the desired-component removed modulated signal from the modulated signal generated by the modulator and output the result.

With the above configuration, since the modulated signal obtained by removing components in the predetermined frequency band is subtracted from the modulated signal generated by the modulator, leakage of the modulated signal to the outside of the predetermined frequency band can be reduced.

The modulation method of an example embodiment of the present invention includes the steps of: generating a modulated signal having a predetermined frequency band in a symbol-by-symbol manner according to an input signal; removing components in the predetermined frequency band from a portion of the modulated signal including a symbol period boundary, to generate a desired-component removed modulated signal; and subtracting the desired-component removed modulated signal from the generated modulated signal.

### Advantages of the Invention

In the example embodiment of the present invention, out-of-band leakage of the modulated signal can be reduced. Since this can be achieved without the necessity of performing window function processing for portions near symbol period boundaries of the modulated signal, decrease in resistance to multipath interference can be avoided.

### BRIEF DESCRIPTION OF THE DRAWINGS

FIG. 1 is a block diagram showing an example configuration of a modulation device of an embodiment of the present invention.

FIG. 2 is a block diagram showing an example configuration of a modulator in FIG. 1.

FIG. 3 is a spectrum chart showing an example of frequency spectra of a signal output from an inverse discrete Fourier transformer in FIG. 2.

FIG. 4 is a view illustrating a CP.

FIG. 5 is a view illustrating a time domain signal output from the modulator in FIG. 1.

FIG. 6 is a block diagram showing a configuration of a variation of the modulator in FIG. 1.

FIG. 7 is a spectrum chart showing an example of a frequency spectrum of a signal output from an inverse discrete Fourier transformer in FIG. 6.

FIG. 8 is a graph showing an example of a time domain signal waveform of a modulated signal extracted by a sampler in FIG. 1.

FIG. 9 is a spectrum chart of the modulated signal of FIG. 8 extracted by the sampler in FIG. 1.

FIG. 10 is a spectrum chart showing an example of a signal output from a modulated signal remover in FIG. 1.

FIG. 11 is a graph showing an example of a time domain signal waveform of a desired-component removed modulated signal.

FIG. 12 is a graph showing an example of a window function used in a waveform shaper in FIG. 1.

FIG. 13 is a spectrum chart showing an example of an output signal of the waveform shaper in FIG. 1.

FIG. 14 is a spectrum chart showing an example of signal ES output from a subtracter in FIG. 1.

FIG. 15 is an example spectrum chart of the entire of the signal ES output from the subtracter in FIG. 1.

FIG. 16 is a block diagram showing a configuration of a variation of the modulation device of FIG. 1.

### DESCRIPTION OF EMBODIMENTS

An embodiment of the present invention will be described with reference to the drawings. Note that, throughout the drawings, any components denoted by reference numerals same in their last two digits are identical or similar to each other.

The function blocks to be described herein can be typically implemented by hardware. For example, each function block can be formed on a semiconductor substrate as part of an integrated circuit (IC). The IC as used herein includes a large-scale integrated circuit (LSI), an application-specific integrated circuit (ASIC), a gate array, a field programmable gate array (FPGA), etc. Alternatively, part or the entire of each function block may be implemented by software. For example, such a function block can be implemented by a program executed on a processor. In other words, each function block to be described herein may be implemented by hardware, by software, or by an arbitrary combination of hardware and software.

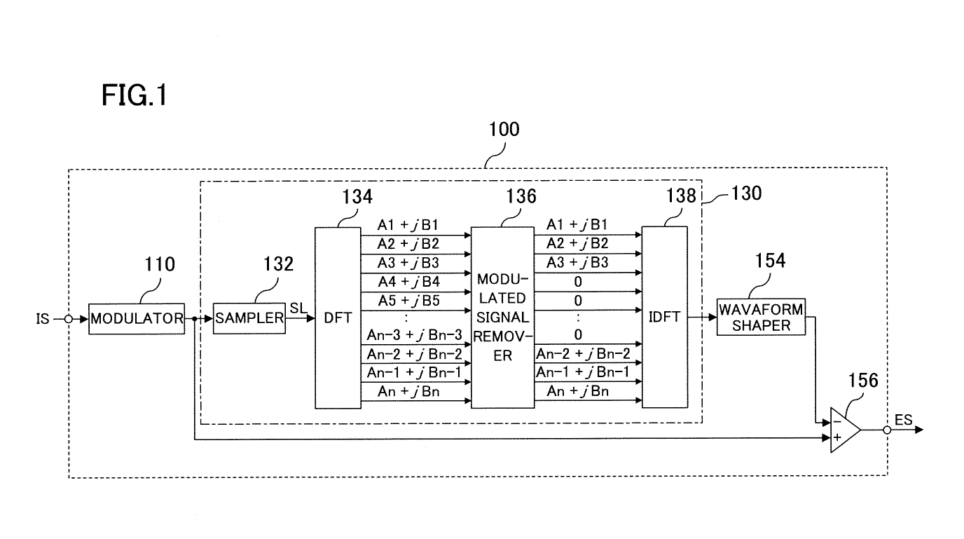

FIG. 1 is a block diagram showing an example configuration of a modulation device 100 of an embodiment of the present invention. The modulation device 100 of FIG. 1 includes a modulator 110, a signal processor 130, a waveform shaper 154, and a subtracter 156.

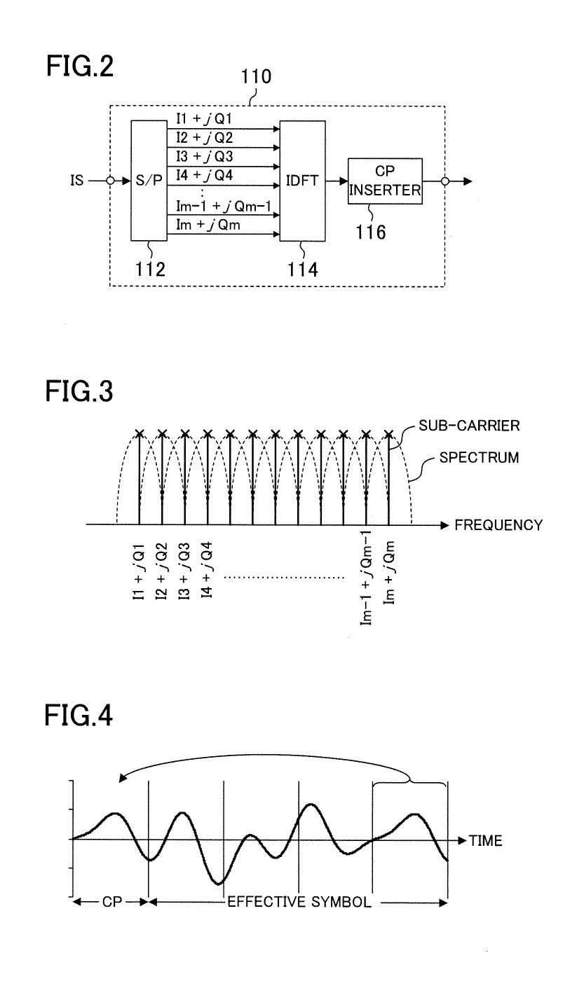

FIG. 2 is a block diagram showing an example configuration of the modulator 110 in FIG. 1. The modulator 110 includes a serial-to-parallel converter 112, an inverse discrete Fourier transformer 114, and a cyclic prefix (CP) inserter 116, to generate an OFDM modulated signal. The serial-to-parallel converter 112 converts an input signal IS to a plurality of complex modulation data sequences I1+jQ1, I2+jQ2, I3+jQ3, I4+jQ4, . . . , Im−1+jQm−1, and Im+jQm. The inverse discrete Fourier transformer 114 transforms the complex modulation data sequences to time domain data sequences. Hereinafter, these time domain data sequences are referred to as effective symbol periods.

FIG. 3 is a spectrum chart showing an example of frequency spectrum of the signal output from the inverse discrete Fourier transformer 114 in FIG. 2. The signal output from the inverse discrete Fourier transformer 114 is a multi-carrier signal comprised of a set of sub-carriers as shown in FIG. 3. The sub-carriers are individually single-carrier modulated signals modulated by the complex modulation data sequences input into the inverse discrete Fourier transformer 114. Each sub-carrier has a sinc spectrum, each zero point of which matches with the center frequency of adjacent sub-carriers. Therefore, no mutual interference occurs between the sub-carriers.

FIG. 4 is a view illustrating a CP. The CP inserter 116 inserts a CP every effective symbol period in the signal output from the inverse discrete Fourier Transformer 114. The CP is a copy of an end portion of an effective symbol period, and inserted at the front of the effective symbol period by the CP inserter 116 as shown in FIG. 4.

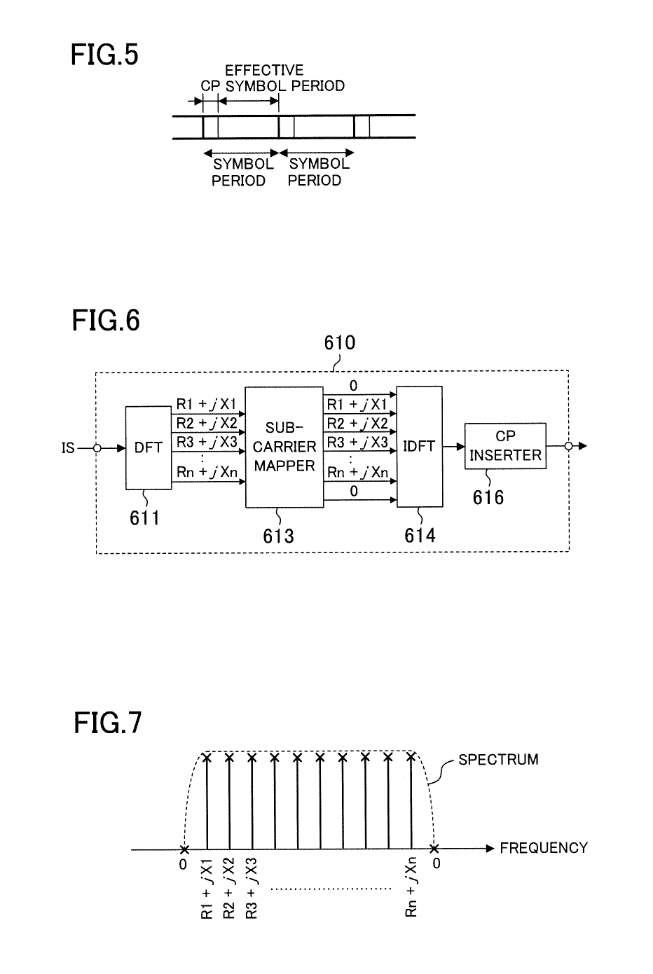

FIG. 5 is a view illustrating the time domain signal output from the modulator 110 in FIG. 1. As shown in FIG. 5, the modulator 110 outputs CP-added symbol periods sequentially. In this way, the modulator 110 generates a modulated signal having a predetermined allocated frequency band in a symbol-by-symbol manner according to the input signal.

In the mobile communication environment, inter-symbol interference in a multipath signal (signal distortion caused by superimposition of adjacent symbol periods on each other, which is hereinafter referred to as multipath interference) hinders high-speed data transmission. By inserting CPs as shown in FIGS. 4 and 5 to give redundancy to the signal, it is possible to suppress the influence of the multipath signal, which has a delay corresponding to the length of the CP, and thus high-speed data transmission can be achieved. Since CPs do not contribute to demodulation of the received signal, it may cause reduction in the efficiency of data transmission. Therefore, the CP length must be decided considering the radio propagation environment (the delay time of the multipath signal) and the required data transmission rate comprehensively.

FIG. 6 is a block diagram showing a configuration of a variation of the modulator 110 in FIG. 1. The modulation device 100 of FIG. 1 may include the modulator 610 of FIG. 6 that generates a DFT-spread OFDM modulated signal, in place of the modulator 110 that generates the OFDM modulated signal. The DFT-spread OFDM modulated signal has a frequency efficiency and resistance to multipath interference as high as those of the OFDM modulated signal.

The modulator 610 of FIG. 6 includes a discrete Fourier transformer 611, a sub-carrier mapper 613, an inverse discrete Fourier transformer 614, and a CP inserter 616. The discrete Fourier transformer 611 transforms an input signal IS to a plurality of frequency domain signals R1+jX1, R2+jX2, R3+jX3, . . . , Rn+jXn. The sub-carrier mapper 613 maps these frequency domain signals to sub-carriers. The inverse discrete Fourier transformer 614 transforms the sub-carriers to a time domain signal. The CP inserter 616 inserts CPs as does the CP inserter 116.

FIG. 7 is a spectrum chart showing an example of a frequency spectrum of the signal output from the inverse discrete Fourier transformer 614 in FIG. 6. This signal, which is a DFT-spread OFDM modulated signal, is a multi-carrier signal, like the OFDM modulated signal of FIG. 3. However, unlike the OFDM modulated signal, the sub-carriers are not independent single carrier modulated signals, but the entire modulated signal has a nature of one single carrier modulated signal. Therefore, the DFT-spread OFDM modulated signal is small in peak-to-average power ratio (PAR) compared with the OFDM modulated signal, and thus easy in increasing the efficiency of a power amplifier. Therefore, the DFT-spread OFDM scheme has been adopted as a transmission modulation scheme for mobile terminals that have a limited power supply capacity, in the 3G Long Term Evolution (LTE) system as the next-generation communication method.

Note that the following description will be made principally assuming that the modulation device 100 has the modulator 110 of FIG. 2 that generates the OFDM modulated signal. The signal processor 130 in FIG. 1 includes a sampler 132, a discrete Fourier transformer 138, a modulated signal remover 136, and an inverse discrete Fourier transformer 138.

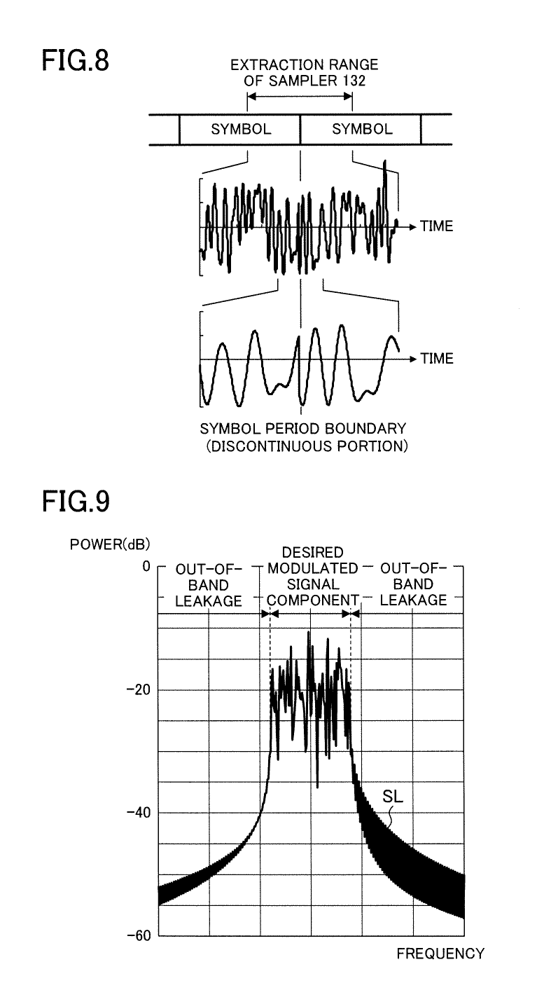

FIG. 8 is a graph showing an example of a time domain signal waveform of a portion of the modulated signal extracted by the sampler 132 in FIG. 1. The sampler 132 extracts a portion including at least one symbol period boundary from the modulated signal generated by the modulator 110, and outputs the extracted modulated signal SL to the discrete Fourier transformer 134. The lower part of FIG. 8 shows in particular an enlarged waveform of the portion of the extracted modulated signal near the symbol period boundary. As shown in FIG. 8, the signal is discontinuous at the symbol period boundary. With the sampler 132 extracting a region including such a discontinuous portion at the symbol period boundary, the resultant signal has out-of-band leakage components in addition to a desired modulated signal.

The discrete Fourier transformer 134 transforms the modulated signal SL extracted by the sampler 132 to frequency domain signals and outputs the result to the modulated signal remover 136. FIG. 9 is a spectrum chart of the modulated signal SL of FIG. 8 extracted by the sampler 132 in FIG. 1.

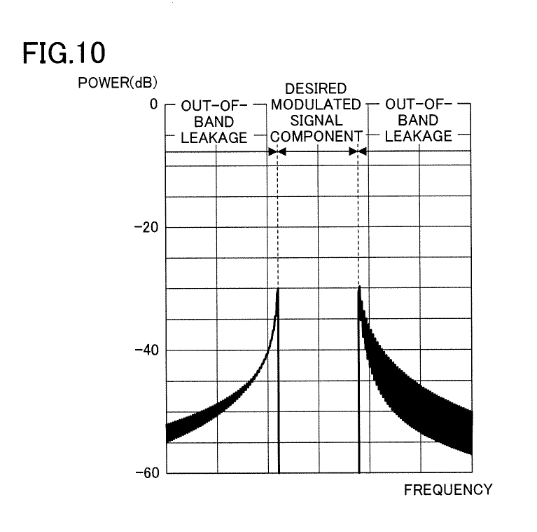

The modulated signal remover 136 removes components in the predetermined frequency band allocated for the modulated signal (modulated signal band) from the frequency domain signals obtained by the discrete Fourier transformer 134, and outputs the resultant in-band component-removed frequency domain signals to the inverse discrete Fourier transformer 138. FIG. 10 is a spectrum chart showing an example signal output from the modulated signal remover 136. The component-removed frequency domain signal includes out-of-band leakage components as shown in FIG. 10. The inverse discrete Fourier transformer 138 transforms the component-removed frequency domain signals from the modulated signal remover 136 to a time domain signal, to generate a desired-component removed modulated signal. As described above, the signal processor 130 removes components in the predetermined frequency band from a portion of the modulated signal including a symbol period boundary, to generate the desired-component removed modulated signal. The desired-component removed modulated signal is basically comprised of out-of-band leakage components.

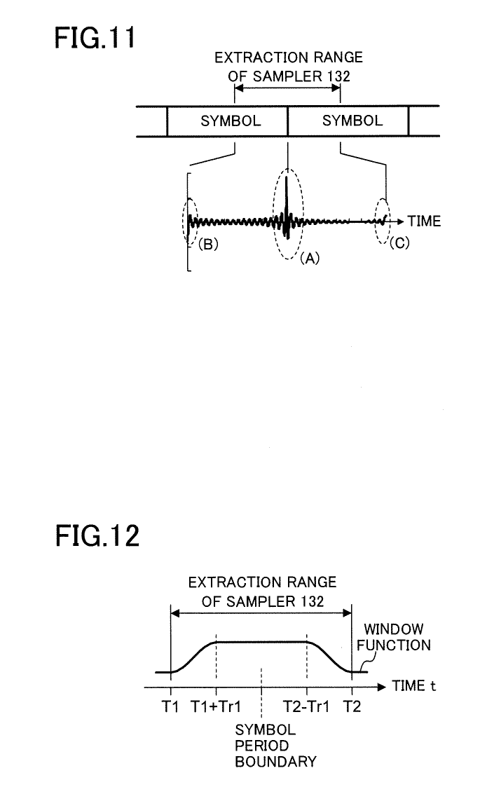

FIG. 11 is a graph showing an example of a time domain signal waveform of the desired-component removed modulated signal. The out-of-band leakage components are large in portions corresponding to the discontinuous portion (A) at the symbol period boundary and the ends (B) and (C) of the range of the extraction by the sampler 132. Note that (B) and (C) in FIG. 11 are portions of pseudo out-of-band leakage components generated from the extraction of the signal by the sampler 132, and that no discontinuous portions corresponding to (B) and (C) exist in the symbol periods of the pre-extracted modulated signal.

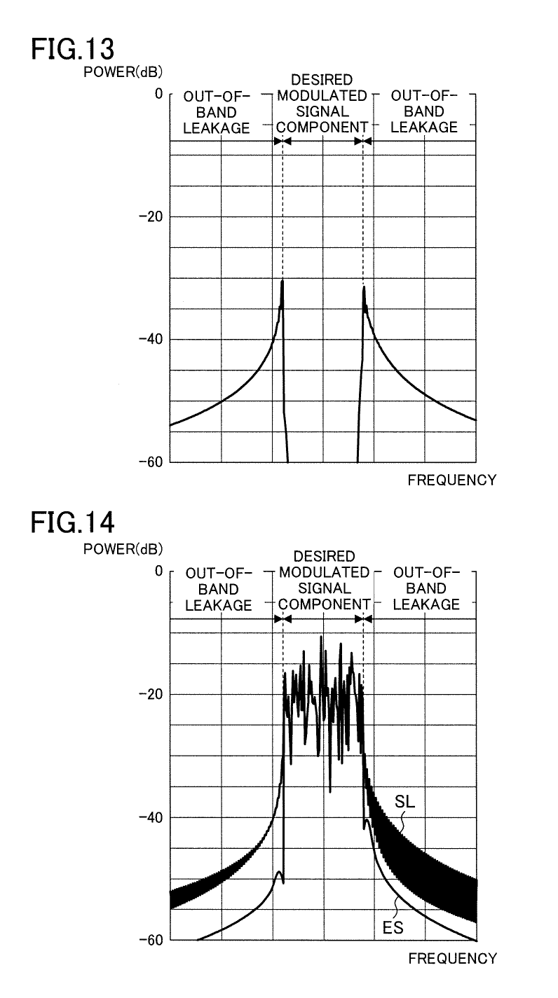

The waveform shaper 154 shapes the desired-component removed modulated signal from the inverse discrete Fourier transformer 138 using a window function and outputs the result to the subtracter 156. With this shaping, the pseudo discontinuous portions (B) and (C) in FIG. 11 can be removed. FIG. 12 is a graph showing an example of the window function used by the waveform shaper 154 in FIG. 1. For example, a window function W1(t) is expressed by

$$\begin{matrix}W 1 ( t ) = 0 ( t < T 1 ) \\ = \{ 1 - cos ( π ( t - T 1 ) / Tr 1 ) \} / 2 ( T 1 \leq t < T 1 + Tr 1 ) \\ = 1 ( T 1 + Tr 1 \leq t \leq T 2 - Tr 1 ) \\ = \{ 1 + cos ( π ( t - ( T 2 - Tr 1 ) ) / Tr 1 ) \} / 2 ( T 2 - Tr 1 < t \leq T 2 ) \\ = 0 ( T 2 < t )\end{matrix}$$

where T1 and T2 are respectively the start and end points of the extraction range, and Tr1 is a ramp length. The waveform shaper 154 multiplies the desired-component removed modulated signal by the window function as shown in FIG. 12, and outputs the multiplication result representing the shaped modulated signal to the subtracter 156. Note that the illustrated window function is a mere example and any other appropriate window function may be used. FIG. 13 is a spectrum chart showing an example of the output signal of the waveform shaper 154 in FIG. 1.

The subtracter 156 subtracts the output signal of the waveform shaper 154 from the modulated signal output from the modulator 110, and outputs the result as a signal ES. FIG. 14 is a spectrum chart showing an example of the signal ES output from the subtracter 156 in FIG. 1. It is found from FIG. 14 that the level of the out-of-band leakage components of the signal ES is lower than the level of the out-of-band leakage components of the modulated signal SL extracted by the sampler 132.

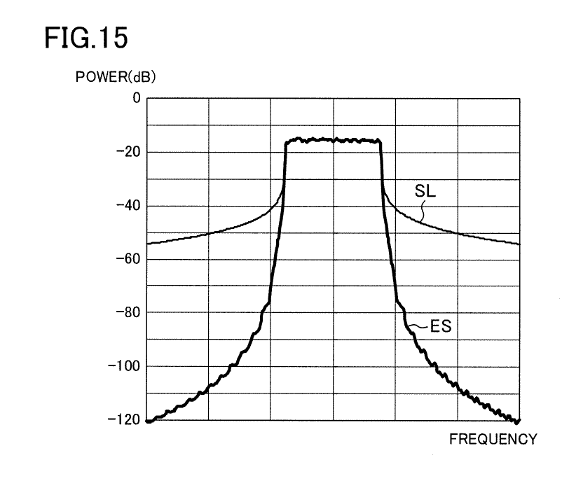

The modulation device 100 of FIG. 1 repeats the processing as described above while changing the portion of the modulated signal to be extracted. FIG. 15 shows an example spectrum chart of the entire signal ES output from the subtracter 156 in FIG. 1. Unlike FIG. 14, FIG. 15 shows the result of processing of the entire of the continuous modulated signal, not only a signal extracted by the sampler 132 as shown in FIG. 11.

Although the frequency components in the modulated signal band are completely canceled by the modulated signal remover 136, a interfering signal leaks into the modulated signal band during the waveform shaping using the window function by the waveform shaper 154. To solve this problem, the modulated signal remover 136 may remove, not only the components in the modulated signal band, but also components outside the modulated signal band that are adjacent to the ends of the modulated signal band. For example, the modulated signal remover 136 removes part of the out-of-band leakage components adjacent to the modulated signal band, together with the components in the modulated signal band, as long as the requirements for reduction of out-of-band leakage of the signal ES output from the subtracter 156 are satisfied, for example. With the removal of part of the out-of-band leakage components adjacent to the modulated signal band, the leakage to the modulated signal band caused by the waveform shaping can be reduced, improving the error vector magnitude (EVM) indicating the quality of the modulated signal.

According to one example, while EVM is 1.28% (average) in the case of removing only the components in the modulated signal band whose bandwidth is 1.08 MHz, EVM becomes 0.47% (average) when components within a bandwidth of 1.23 MHz are removed to include ones adjacent to the modulated signal band, and 0.30% (average) when components within a bandwidth of 1.38 MHz are removed.

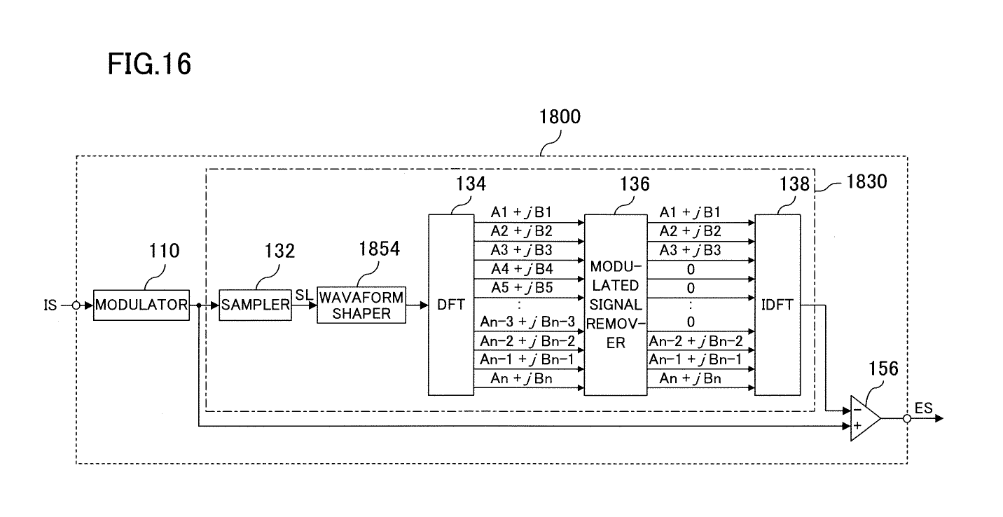

FIG. 16 is a block diagram showing a configuration of a variation of the modulation device of FIG. 1. The modulation device 1800 of FIG. 16 includes a signal processor 1830, which includes a waveform shaper 1854 between the sampler 132 and the discrete Fourier transformer 134. The waveform shaper 1854 multiplies the output of the sampler 132 by the window function shown in FIG. 12, for example, and outputs the shaped modulated signal to the discrete Fourier transformer 134. The discrete Fourier transformer 134 transforms the modulated signal shaped by the wave shaper 1854 to frequency domain signals. Like the modulation device 100 of FIG. 1, the modulation device 1800 of FIG. 16 can also reduce out-of-band leakage components of the modulated signal.

It is desirable that the number of sample points at which the sampler 132 executes extraction is the n-th power of 2. It is also desirable that the number of sample points is set at a number equal to or more than the number of sample points corresponding to twice the ramp length Tr1 of the window function used in the waveform shaper 154.

It is desirable that the start of the range of extraction by the sampler 132 is at a position ahead from a symbol period boundary by at least the number of sample points corresponding to the ramp length Tr1, and the end of the range is at a position behind the symbol period boundary by at least the number of sample points corresponding to the ramp length Tr1. This is made to ensure that no symbol period boundary exists in any ramp segment.

In waveform shaping of a portion of the modulated signal near a symbol period boundary, the reduced amount of out-of-band leakage components and the resistance to multipath interference are in a trade-off relationship. In the embodiment described above, however, they can be separated. In other words, in the above embodiment, since waveform shaping of a portion of the modulated signal near a symbol period boundary is unnecessary, it is possible to reduce out-of-band leakage of the modulated signal while avoiding reduction in resistance to multipath interference.

Also, in the embodiment described above, it is possible to achieve in-band gain flatness, low group delay characteristics, and sharp out-of-band leakage reduction characteristics. Moreover, it is possible to respond to a type of time/frequency scheduling that involves high-speed change of block allocation in a channel band according to the momentarily changing radio propagation environment and information rate.

The many features and advantages of the present invention are apparent from the written description, and thus, it is intended by the appended claims to cover all such features and advantages of the invention. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

### INDUSTRIAL APPLICABILITY

As described above, in the embodiments of the present invention, out-of-band leakage of the modulated signal can be suppressed. Thus, the present invention is useful in modulation devices, etc.

### DESCRIPTION OF REFERENCE CHARACTERS

100, 1800 Modulation Device
110, 610 Modulator
130, 1830 Signal Processor
132 Sampler
134 Discrete Fourier Transformer
136 Modulated signal Remover
138 Inverse Discrete Fourier Transformer
154, 1854 Waveform Shaper
156 Subtracter

1. A modulation device, comprising:
a modulator configured to generate a modulated signal having a predetermined frequency band in a symbol-by-symbol manner according to an input signal;
a signal processor configured to remove components in the predetermined frequency band from a portion of the modulated signal including a symbol period boundary, to generate a desired-component removed modulated signal; and
a subtracter configured to subtract the desired-component removed modulated signal from the modulated signal generated by the modulator and output the result.

2. The modulation device of claim 1, further comprising:
a waveform shaper configured to shape the desired-component removed modulated signal using a window function,
wherein
the subtracter subtracts the modulated signal shaped by the waveform shaper from the modulated signal generated by the modulator.

3. The modulation device of claim 1, wherein
the signal processor includes
a sampler configured to extract the portion including a symbol period boundary from the modulated signal,
a Fourier transformer configured to transform the modulated signal extracted by the sampler to a frequency domain signal,
a modulated signal remover configured to remove the components in the predetermined frequency band from the frequency domain signal, and
an inverse Fourier transformer configured to transform the component-removed frequency domain signal to a time domain signal to generate the desired-component removed modulated signal.

4. The modulation device of claim 3, further comprising:
a waveform shaper configured to shape the modulated signal extracted by the sampler using a window function,
wherein
the Fourier transformer transforms the modulated signal shaped by the waveform shaper to the frequency domain signal.

5. The modulation device of claim 1, wherein
the signal processor also removes components outside the predetermined frequency band that are adjacent to an end of the predetermined frequency band.

6. The modulation device of claim 1, wherein
the modulator generates the modulated signal by performing inverse Fourier transform.

7. A modulation method, comprising the steps of:
generating a modulated signal having a predetermined frequency band in a symbol-by-symbol manner according to an input signal;
removing components in the predetermined frequency band from a portion of the modulated signal including a symbol period boundary, to generate a desired-component removed modulated signal; and
subtracting the desired-component removed modulated signal from the generated modulated signal.
